(19) United States
(12) Patent Application Publication
(10) Pub. No.: US 2011/0208397 A1
(43) Pub. Date: Aug. 25, 2011

(54) STARTING-CLUTCH CONTROL APPARATUS

(75) Inventors: Ayae IKURO, Wako (JP); Takahiro Eguchi, Wako (JP); Takeshi Kurata, Wako (JP); Tamotsu Kotegawa, Wako (JP); Satoshi Yamashita, Wako (JP); Yoshiteru Matsuura, Wako (JP); Satoshi Kanazawa, Wako (JP)

(73) Assignee: HONDA MOTOR CO., LTD., Tokyo (JP)

(21) Appl. No.: 12/975,371

(22) Filed: Dec. 22, 2010

(30) Foreign Application Priority Data
Feb. 23, 2010 (JP) 2010-037750

(51) Int. Cl. F16D 48/06

(52) U.S. Cl. 701/68

(57) ABSTRACT

A starting-clutch control apparatus is configured to control connection between a driving side and a driven side of a vehicle using a starting clutch disposed therebetween. A driving-shaft rotation speed detector is configured to detect a rotation speed of a driving shaft of the starting clutch. A driven-shaft rotation speed detector is configured to detect a rotation speed of a driven shaft of the starting clutch. A cumulative work amount calculator is configured to calculate a cumulative work amount of the starting clutch based on pressure applied to the starting clutch, the rotation speed of the driving shaft, and the rotation speed of the driven shaft. A torque output restricting device is configured to restrict an output torque of a driving source of the vehicle when the starting clutch is in a transient engagement state and the cumulative work amount exceeds a first specific value.

### CROSS-REFERENCE TO RELATED APPLICATIONS

The present application claims priority under 35 U.S.C. §119 to Japanese Patent Application No. 2010-037750, filed Feb. 23, 2010, entitled “Starting-clutch control apparatus.” The contents of this application are incorporated herein by reference in their entirety.

### BACKGROUND OF THE INVENTION

1. Field of the Invention

The present invention relates to a starting-clutch control apparatus.

2. Description of the Related Art

One known example of a control apparatus for controlling a transmission torque of a clutch when a vehicle starts is a starting-clutch control apparatus described in Japanese Unexamined Patent Application Publication No. 9-72353. With this apparatus, to obtain good starting performance when a vehicle starts, stating control is carried out with a low engine RPM at which a large input torque is obtainable.

However, when oil used as a medium for transmitting a force for actuating a clutch is supplied from an oil pump to the clutch, because the oil is supplied every time the engine rotates, the quantity of flow of the oil is substantially proportional to the engine RPM. Therefore, for a low engine RPM, the amount of oil supplied is reduced and performance of cooling by the oil is also decreased. If this state continues, the clutch remains at an impermissible high temperature, and this is a cause of hastening the deterioration of the clutch.

In particular, with continuation of a continuous stall condition, for example, during climbing a hill, continuation of a high temperature state may hasten the deterioration of the clutch. One possible approach to avoiding this situation is the use of a large-capacity oil pump. Unfortunately, however, a large-capacity oil pump increases pump friction and reduce fuel efficiency.

### SUMMARY OF THE INVENTION

According to one aspect of the invention, a starting-clutch control apparatus is configured to control connection between a driving side and a driven side of a vehicle using a starting clutch disposed therebetween. The starting-clutch control apparatus includes a driving-shaft rotation speed detector, a driven-shaft rotation speed detector, a cumulative work amount calculator, and a torque output restricting device. The driving-shaft rotation speed detector is configured to detect a rotation speed of a driving shaft of the starting clutch. The driven-shaft rotation speed detector is configured to detect a rotation speed of a driven shaft of the starting clutch. The cumulative work amount calculator is configured to calculate a cumulative work amount of the starting clutch based on pressure applied to the starting clutch, the rotation speed of the driving shaft, and the rotation speed of the driven shaft. The torque output restricting device is configured to restrict an output torque of a driving source of the vehicle when the starting clutch is in a transient engagement state and the cumulative work amount exceeds a first specific value.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates a schematic configuration of a starting-clutch control apparatus according to an embodiment of the invention;

FIG. 2 is a flowchart of a procedure of a starting-clutch control process performed by a central processing unit (CPU) of a transmission control device illustrated in FIG. 1;

FIG. 3 is a flowchart of a procedure of a precondition check process at step ST1 illustrated in FIG. 2;

FIG. 4 is a flowchart of a procedure of a work and power calculation process at step ST2 illustrated in FIG. 2;

FIG. 5 is a flowchart of a procedure of a control-state selection process at step ST3 illustrated in FIG. 2;

FIG. 6 is a flowchart of a procedure of a torque cooperative control process at step ST4 illustrated in FIG. 2; and

FIGS. 7A to 7E illustrate examples of changes in parameters of power PWSC of a starting clutch, cooperative torque TQSC, engine RPM NE, cumulative work Qsc of the starting clutch, and oil temperature OT of the starting clutch according to the embodiment of the invention with respect to time.

### DESCRIPTION OF THE EMBODIMENTS

The embodiments will now be described with reference to the accompanying drawings, wherein like reference numerals designate corresponding or identical elements throughout the various drawings.

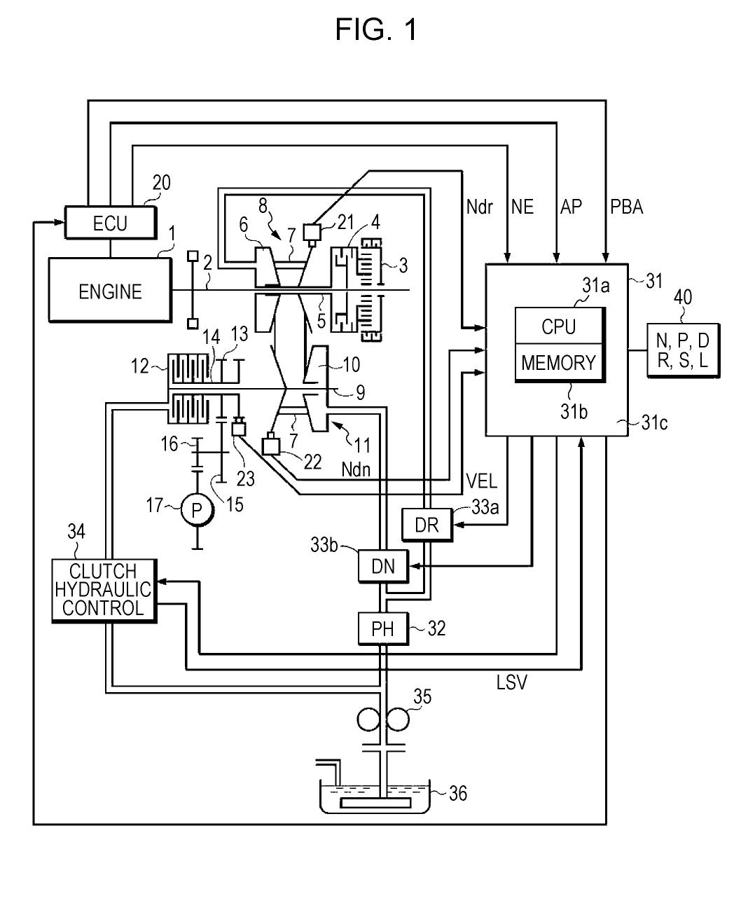

FIG. 1 illustrates a configuration of a starting-clutch control apparatus according to an embodiment of the invention. The present embodiment is a clutch control apparatus for a vehicle having an engine (internal-combustion engine) as a driving source and employs a continuously variable transmission (CVT) as the transmission of the vehicle.

Referring to FIG. 1, a driving shaft 2 for transmitting an output from an engine 1 of a vehicle is coupled to an input shaft 5 of the transmission through a forward-reverse switching mechanism 3 and a forward clutch 4. The input shaft 5 is provided with a variable pulley (hereinafter referred to as a driving-side pulley) 8. The driving-side pulley 8 can change the width of a V groove, that is, the diameter of winding of a transmission belt 7 using a variable hydraulic cylinder 6.

The transmission belt 7 is wound around the drive-side pulley 8 of the transmission and a variable pulley (hereinafter referred to as a driven-side pulley) 11 disposed on a driven shaft 9 of the transmission. The driven-side pulley 11 also can change the width of a V groove, that is, the diameter of winding of the transmission belt 7 using a variable hydraulic cylinder 10.

The above-described elements 3 to 11 form a continuously variable transmission. The driven shaft 9 is coupled to an output shaft 14 provided with an output gear 13 through a starting clutch 12 including a clutch piston (not illustrated). The output gear 13 is coupled to a differential gear 17 through intermediate gears 15 and 16.

When the vehicle is in gear, a turning force transmitted from the engine 1 to the driving shaft 2 is transmitted to the driving-side pulley 8 through the forward clutch 4 and then to the driven-side pulley 11 through the transmission belt 7. In response to pressing down on an accelerator pedal, the turning force of the driven-side pulley 11 is transmitted to the output shaft 14 through the starting clutch 12, and the turning force of the output shaft 14 is transmitted to right and left driving wheels (not illustrated) through the output gear 13, intermediate gears 15 and 16, and differential gear 17.

The starting clutch 12 is actuated by oil pressure applied to the clutch piston of the starting clutch 12, and the oil pressure is controlled by a starting-clutch hydraulic control device 34. An oil intake side of the starting-clutch hydraulic control device 34 is connected to an oil tank 36 through an oil pump 35. The starting-clutch hydraulic control device 34 includes a linear solenoid valve (LS) actuated by power applied to the solenoid and generates oil pressure to the clutch piston using oil stored in the oil tank 36.

Rotation of the engine 1 is controlled by an electronic control unit (ECU) 20. The ECU 20 is connected to a transmission control device 31 for controlling the oil pressure of each of the hydraulic cylinders 6 and 10.

The transmission control device 31 includes a central processing unit (CPU) 31a for executing various kinds of computation, a memory 31b including a read-only memory (ROM) and random-access memory (RAM) for storing various computation programs executable by the CPU 31a, various tables, and results of computation, and an input and output interface 31c for receiving various electric signals and outputting driving signals (electric signals) based on results of computation.

For the present embodiment, the transmission control device 31 is configured as a starting-clutch control apparatus that also performs starting-clutch control. Accordingly, the CPU 31a of the transmission control device 31 performs starting-clutch control.

The transmission control device 31 receives values of an engine RPM NE, throttle valve opening angle AP, and intake pipe absolute pressure PBA output from the ECU 20.

The transmission control device 31 also receives outputs from an input-shaft rotation sensor 21, a driven-shaft rotation sensor 22, and an output-shaft rotation sensor 23. The input-shaft rotation sensor 21 is disposed in the vicinity of the driving-side pulley 8 to detect the number of revolutions Ndr of the input shaft 5. The driven-shaft rotation sensor 22 is disposed in the vicinity of the driven-side pulley 11 to detect the number of revolutions Ndn of the driven shaft 9. The output-shaft rotation sensor 23 is disposed in the vicinity of the output shaft 14 to detect the vehicle speed VEL.

The transmission control device 31 supplies a current signal for actuating the liner solenoid valve of the starting-clutch hydraulic control device 34 and detects a voltage value LSV of a voltage applied to that solenoid.

The transmission control device 31 is also connected to a selector (reduction ratio selecting device) 40 of the automatic transmission and receives a detected state of a selection lever (not illustrated) of the selector 40. For the present embodiment, the selector 40 can select six ranges of neutral (N), parking (P), drive (D), reverse (R), second (S), and low (L).

The transmission control device 31 outputs a signal for generating a driving-side pulley oil pressure DR and a driven-side pulley oil pressure DN to control oil pressure generating devices 33a and 33b, respectively, a signal for actuating the linear solenoid valve of the starting-clutch hydraulic control device 34 to the starting-clutch hydraulic control device 34, and a signal for controlling an output torque of the engine 1 to the ECU 20.

An oil intake side of a PH generating device 32 is connected to the oil tank 36 through the oil pump 35. An oil supply side of the PH generating device 32 is connected to an oil intake side of each of the control oil pressure generating devices 33a and 33b, and the oil pressure is supplied from the PH generating device 32 to the control oil pressure generating devices 33a and 33b.

An oil supply side of the control oil pressure generating device 33a is connected to the hydraulic cylinder 6. An oil supply side of the control oil pressure generating device 33b is connected to an oil intake side of the hydraulic cylinder 10. An oil pressure controlled in response to a control signal from the transmission control device 31 is supplied to each of the hydraulic cylinders 6 and 10.

In this way, in response to the oil pressures supplied from the control oil pressure generating devices 33a and 33b to the hydraulic cylinders 6 and 10, the width of the V groove of the driving-side pulley 8 and that of the driven-side pulley 11 are determined, and thus the transmission gear ratio of the CVT is determined.

Next, starting-clutch control performed by the CPU 31a of the transmission control device 31 serving as the starting-clutch control apparatus is described below. For the present embodiment, the CPU 31a operates as a driven-shaft number-of-revolutions detecting unit, a cumulative work calculating unit, a torque output restricting unit, a power calculating unit, a temperature estimating unit, and a second torque output restricting unit of the embodiment of the present invention.

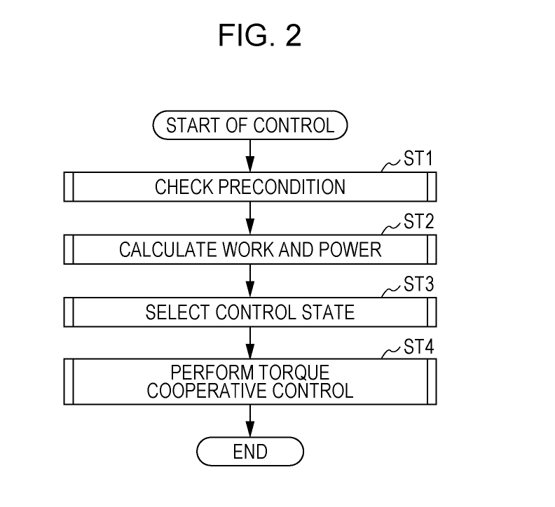

FIG. 2 is a flowchart of a procedure of a control process performed by the CPU 31a of the transmission control device 31. A control program illustrated in this flowchart is called and executed for every specific time (e.g., 10 msec).

For this control process, first, in step ST1, a precondition for determining whether the state of a vehicle is normal or not is checked. Next, in step ST2, work and power are calculated. Then, in step ST3, a control state is selected. Then, in step ST4, torque cooperative control is performed. The control process is completed.

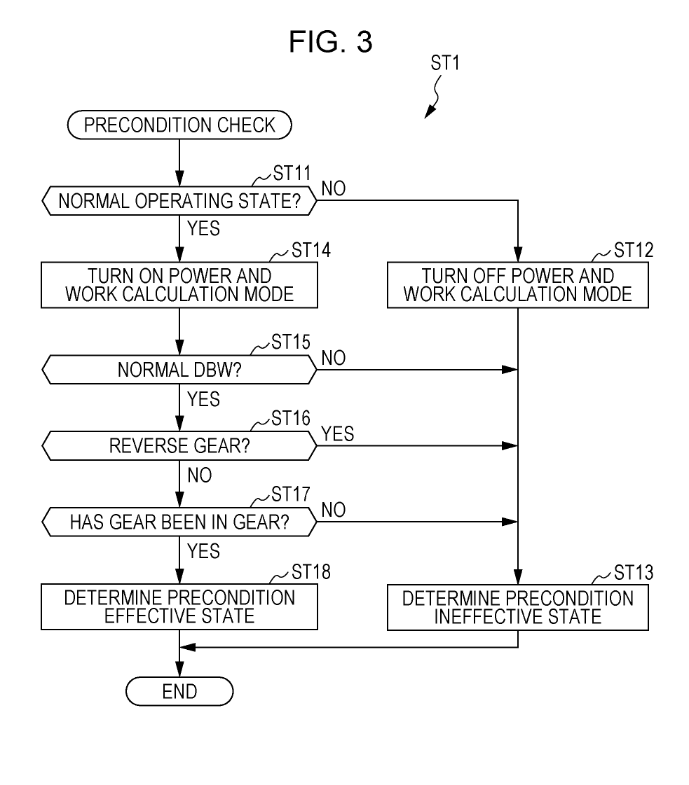

The processes of steps ST1 to ST4 are described below with reference to FIGS. 3 to 6.

FIG. 3 is a flowchart of a procedure of the precondition check process performed at step ST1 illustrated in FIG. 2.

First, in step ST11, whether the operating state of a vehicle is normal or not is determined. For example, it is determined whether a value of each of the engine RPM NE, the driving-side number of revolutions Ndr, the driven-side number of revolutions Ndn, and the vehicle speed VEL is normal or not and whether the operation of, for example, the linear solenoid of the starting clutch is normal or not. If there is anomaly in any one of these values and operation, because power cannot be calculated, it is determined that the operation state is not normal (NO in step ST11), and the process proceeds to step ST12, where power and work calculation mode is turned off. Then, in step ST13, a precondition ineffective state is determined, and the process is completed.

If it is determined that the operating state is normal (YES in step ST11), the process proceeds to step ST14, where the power and work calculation mode is turned on. Then, in step ST15, it is determined whether the drive-by-wire DBW is normal or not. If it is not normal (NO in step ST15), the process proceeds to step ST13, which is previously described.

If it is determined that the DBW is normal (YES in step ST15), the process proceeds to step ST16, where it is determined whether the selection lever of the selector 40 is in the reverse gear (R). If it is in the reverse gear (YES in step ST16), the process proceeds to step ST13, which is previously described.

If it is not in the reverse gear (NO in step ST16), the process proceeds to step ST17, where the selection lever of the selector 40 has been in any one of the drive gear (D), second gear (S), and low gear (L). If it has not been in gear (NO in step ST17), the process proceeds to step ST13, which is previously described. If it has been in any of the above gears (YES in step ST17), the process proceeds to step ST18. In step ST18, a precondition effective state is determined, and the process is completed.

In this way, when the vehicle is in a normal state and in any one of the forward gears, the precondition effective state is determined; otherwise the precondition ineffective state is determined.

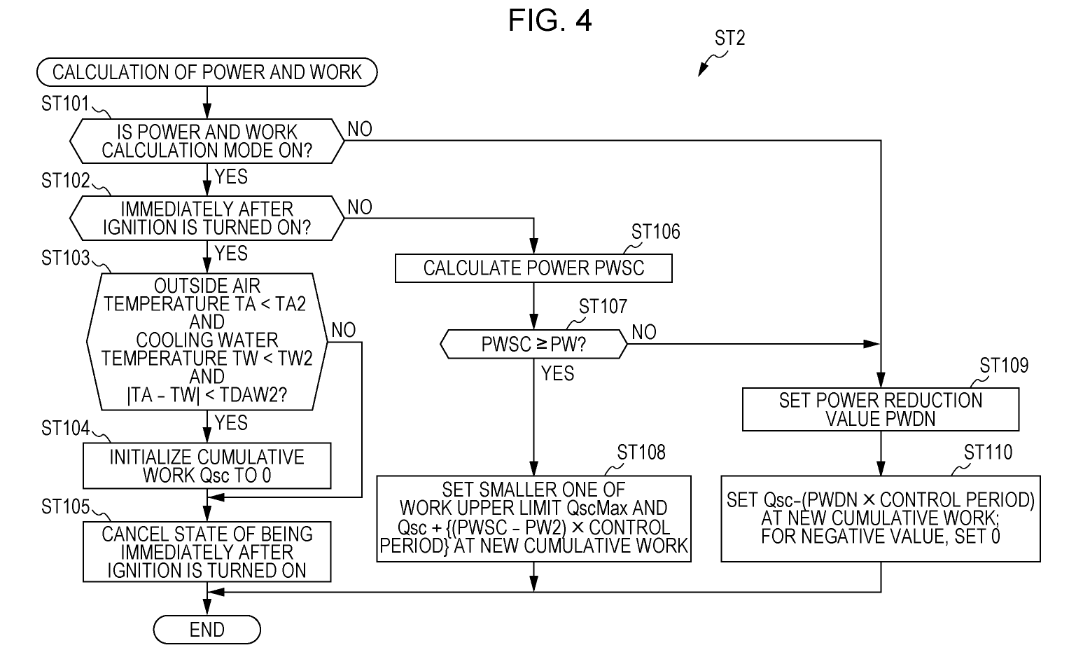

FIG. 4 is a flowchart of a procedure of a work and power calculation process performed at step ST2 illustrated in FIG. 2.

First, in step ST101, it is determined whether the power and work calculation mode set in step ST12 or ST14 is ON or OFF. If it is ON (YES in step ST101), the process proceeds step ST102, where it is determined whether the vehicle is immediately after the ignition is turned on. If the vehicle is immediately after the ignition is turned on (YES in step ST102), the process proceeds to step ST103.

In step ST103, it is determined whether the outside air temperature TA is below a specific value TA2, whether the water temperature TW of water for cooling the engine is below a specific value TW2, and whether the difference (absolute value) between the outside air temperature TA and the water temperature TW is below a specific value TDAW2. The specific values TA2 and TW2 are set at values by which the outside air temperature TA and the water temperature TW can be determined to be sufficiently low, respectively. The specific value TDAW2 is set at a value by which it can be determined that a long time has elapsed since the engine is turned off. That is, it is determined from the difference between the outside air temperature TA and the water temperature TW whether a long time has elapsed since the engine is turned off.

If the determination in step ST103 is YES, the process proceeds to step ST104. In step ST104, the cumulative work Qsc of the starting clutch is initialized to zero, and the process proceeds to step ST105. If the determination in step ST103 is NO, the process proceeds to step ST105. That is, only when it is determined that a sufficiently long time has elapsed since the engine is turned off, the cumulative work Qsc is initialized to zero. This aims to prevent the cumulative work Qsc from being initialized to zero when the ignition is turned on in a state where the starting clutch is not sufficiently cooled.

In step ST105, a state of being immediately after the ignition is turned on is cancelled. Accordingly, the determination in step ST102 is YES only once immediately after the ignition is turned on; steps ST103 to ST105 are performed only once. After that, steps ST106 to ST110, which are described below, are performed.

That is, the cumulative work Qsc may be initialized to zero only immediately after the ignition is turned on. If the ignition is turned on when a sufficiently long time has not elapsed since the engine is turned off, the cumulative work Qsc is not initialized to zero.

If in step ST102 it is determined that the vehicle is not immediately after the ignition is turned on (NO in step ST102), the process proceeds to step ST106, where the power PW of the starting clutch in the present control period is calculated. An example calculating method is described below.

First, the thrust FSC of the clutch piston of the starting clutch is calculated by the following expression 1:

FSC=(PCCMD+Pcf−PCRP)×ASC 1

where PCCMD is the target value of pressure acting on the starting clutch, Pcf is the pressure generated by centrifugal force produced in rotation of oil inside the starting clutch, PCRP is the creep generation pressure of the starting clutch, and ASC is the area of the piston of the starting clutch.

The pressure acting on the driving side and the driven side of the starting clutch is obtained by (PCCMD+Pcf−PCRP) in the above expression 1, and the thrust FSC of the clutch piston of the starting clutch is obtained by multiplying the obtained value by the area of the piston of the starting clutch.

Then, the power PWSC is calculated by the following expression 2:

PWSC=FSC×(the number of revolutions of the driven-side pulley 11−the number of revolutions of the vehicle side)×K 2

where the number of revolutions of the driven-side pulley 11 is an output of the driven-shaft rotation sensor 22 and represents the number of revolutions of the driving shaft of the starting clutch, the number of revolutions of the vehicle side represents the number of revolutions of the driven shaft of the starting clutch, and K is a coefficient for converting the value obtained by multiplying the thrust of the clutch piston of the starting clutch by the difference between the number of revolutions of the driven-side pulley 11 and the number of revolutions of the vehicle side into the power of the starting clutch. Because only gears of a fixed gear ratio are disposed between the driven shaft of the starting clutch and the wheels of the vehicle, the number of revolutions of the driven shaft of the starting clutch is determined by calculation from the vehicle speed VEL.

The driven-shaft rotation sensor 22 corresponds to a driving-shaft number-of-revolutions detecting unit of the embodiment of the present invention. The process for determining the number of revolutions of the driven shaft of the starting clutch from an output from the output-shaft rotation sensor 23 corresponds to the driven-shaft number-of-revolutions detecting unit of the embodiment of the present invention. Step ST106 corresponds to the power calculating unit of the embodiment of the present invention.

After the power is calculated in the above way, the process proceeds to step ST107. In step ST107, it is determined whether the power PWSC calculated in step ST106 is at or above a specific value PW. The specific value PW is described below.

If the determination in step ST107 is YES, the process proceeds to step ST108. In step ST108, the larger one of a previously set work upper limit QscMax and the value obtained by integrating the subtraction of the specific value PW2 from the power PWSC calculated in step ST106 for a control period with respect to the time axis and then adding the value to the cumulative work Qsc at the present time is set as a new cumulative work Qsc.

The specific value PW2 aims at correcting the power PWSC and is typically set at zero. The work upper limit QscMax is set so as to aim to prevent the cumulative work Qsc from continuously increasing. An increase in the temperature of the starting clutch does not continue while the starting clutch continues slipping, and the increase becomes saturated at a certain temperature.

In the above way, the cumulative work Qsc is calculated so as to be at or above the cumulative work at the present time.

If the determination in step ST101 or ST107 is NO, the process proceeds to step ST109, where a power reduction value PWDN is set. The power reduction value PWDN is a value for reducing the cumulative work Qsc. Cooling performance of the clutch using oil is determined based on the engine RPM NE and the temperature OT of working fluid of the starting clutch (oil stored in the oil tank 36 for the present embodiment), hereinafter referred to as “oil temperature.” The power reduction value PWDN is a value determined based on the cooling performance.

The oil temperature OT is estimated by the CPU 31a serving as the temperature estimating unit of the embodiment of the present invention. The temperature estimating unit calculates the value of resistance of the solenoid from the current value of a current supplied to the solenoid and the voltage value LSV of a voltage applied to the solenoid of the starting-clutch hydraulic control device 34, determines the temperature of the solenoid based on a table indicating the relationship between the resistance value of the solenoid and the temperature, and estimates the determined temperature at the oil temperature OT.

After step ST109, the process proceeds to step ST110, where the value obtained by integrating the power reduction value PWDN for a control period with respect to the time axis and subtracting it from the cumulative work Qsc is set as a new cumulative work Qsc. If the obtained cumulative work Qsc is negative, the new cumulative work Qsc is set at zero. Accordingly, the cumulative work Qsc is set so as to be at or below the cumulative work at the present time.

In this way, the cumulative work Qsc increases in step ST108 and decreases in step ST110. When the power PWSC in the present control period is small, a load on the clutch is small (heat occurring in the clutch is low). Accordingly, cooling using oil is sufficient, and it is not necessary to accumulate work (heat stored in the clutch). The above specific value PW is set at a value by which this switching can be enabled.

After step ST105, ST108, or ST110, the work and power calculation process is completed.

Steps ST106 to ST110 correspond to the cumulative work calculating unit of the embodiment of the present invention.

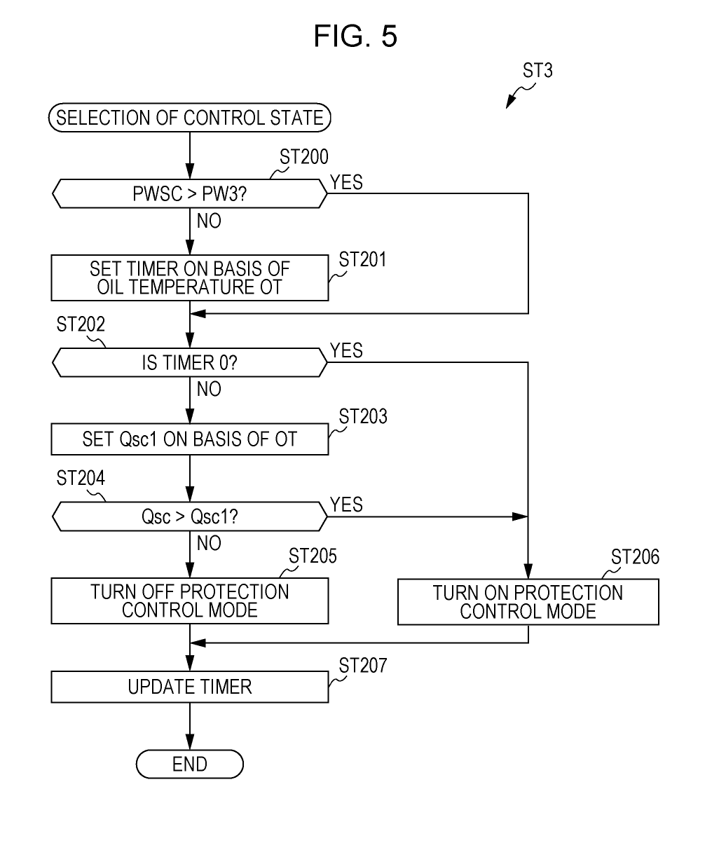

FIG. 5 is a flowchart of a procedure of a control state selection process performed at step ST3 illustrated in FIG. 2.

First, in step ST200, it is determined whether the power PWSC calculated in step ST106 exceeds a specific value PW3 calculated in step ST106. If the power PWSC does not exceed PW3 (NO in step ST200), the process proceeds to step ST201. In step ST201, the timer value is set based on the oil temperature OT, and the process proceeds to step ST202. If the power PWSC exceeds PW3 (YES in step ST200), the process proceeds to step ST202. The reason why the timer value is not set when the power PWSC exceeds PW3 is described below.

In step ST201, the timer value is set at a larger value when the oil temperature OT is low and at a smaller value when the oil temperature OT is high, and the process proceeds to step ST202. The reason why the timer value is set in this way is described below.

In step ST202, it is determined whether the timer value is zero or not. If the timer value is not zero (NO in step ST202), the process proceeds to step ST203. In step ST203, a specific value Qsc1 is set based on the oil temperature OT, and the process proceeds to step ST204. The specific value Qsc1 is set at a larger vale when the oil temperature OT is low and at a smaller value when the oil temperature OT is high. The reason why the value Qsc1 is set in this way is described below.

In step ST204, it is determined whether the cumulative work Qsc set in step ST108 or ST110 is above the specific value Qsc1 set in step ST203. If the cumulative work Qsc is not above the specific value Qsc1 (NO in step ST204), the process proceeds to step ST205, where protection control mode is turned off.

If the timer value is zero in step ST202 or the cumulative work Qsc is above the specific value Qsc1 in step ST204, the process proceeds to step ST206, where the protection control mode is turned on.

After steps ST205 and 5206, the process proceeds to step ST207. In step ST207, the timer value is updated, and the process is completed. The timer value is set at a value smaller than the present value; if the present value is zero, zero is set.

Accordingly, a condition of turning on the protection control mode is that the timer is zero or the cumulative work Qsc is above the specific value Qsc1.

If the power PWSC exceeds the specific value PW3 (e.g., in a stall condition), the timer value is not set and remains at a value updated in step ST207. If the stall condition continues, the timer value is updated, and if that state continues for a certain period, the timer becomes zero. That is, the timer value indicates a period for which continuation of a stall condition is allowable to the oil temperature OT in a non-stall condition. Accordingly, in step ST201, the timer value is set in step ST201 at a larger value when the oil temperature OT is low and at a smaller value when the oil temperature OT is high.

The reason why in step ST203 the specific value Qsc1 is set at a larger value when the oil temperature OT is low and at a smaller value when the oil temperature OT is high is that, even for a short-time stall condition, if the oil temperature OT is high, a small amount of lubricating oil and insufficient cooling may cause degradation in the starting clutch, the protection control mode is preferably turned on. When the oil temperature OT exceeds a specific value, the protection control mode can be forcefully turned on by setting the specific value Qsc1 at zero.

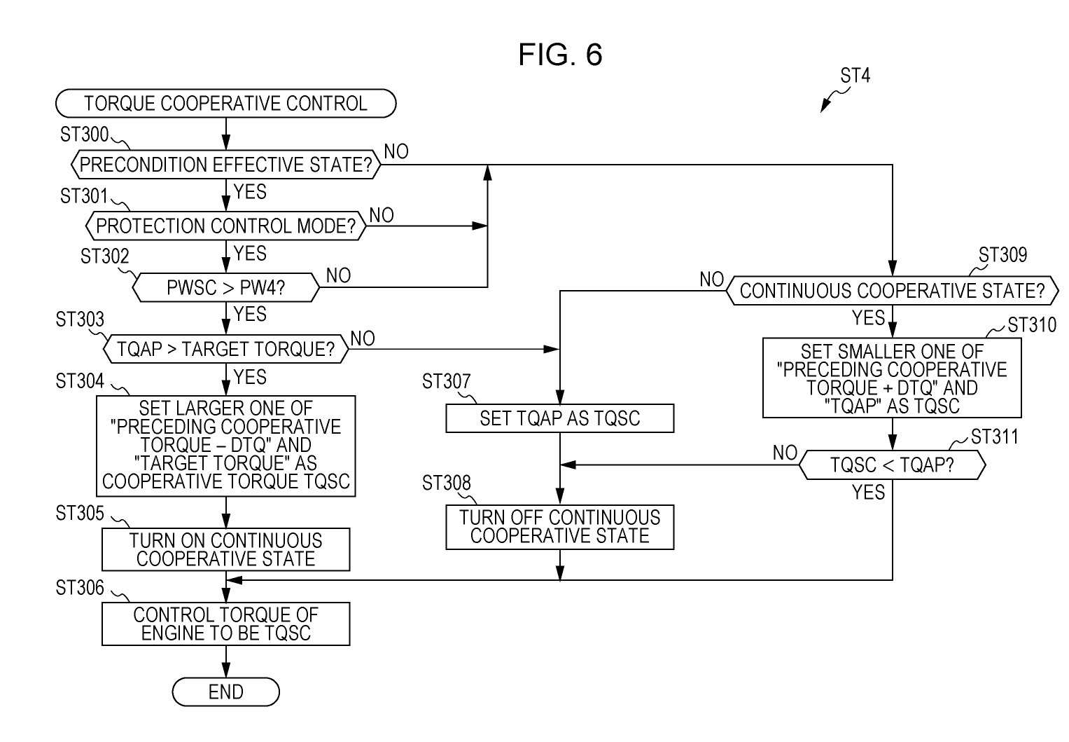

FIG. 6 is a flowchart of a procedure of a torque cooperative control process performed at step ST4 illustrated in FIG. 2.

First, in step ST300, it is determined whether the precondition set in step ST13 or ST18 is effective. If the precondition is effective (YES in step ST300), the process proceeds to step ST301.

In step ST301, it is determined whether the protection control mode set in step ST205 or ST206 is ON or OFF. If it is ON (YES in step ST301), the process proceeds to step ST302.

In step ST302, it is determined whether the power PWSC calculated in step ST106 exceeds a specific value PW4. If PWSC exceeds PW4 (YES in step ST302), the process proceeds to step ST303. The specific value PW4 is set such that torque restriction is needed or not in consideration of heat occurring in the starting clutch in the present control period and oil cooling performance.

In step ST303, it is determined whether an accelerator pedal request torque TQAP determined in response to pressing down on the accelerator pedal exceeds a target torque. If TQAP exceeds the target torque (YES in step ST303), the process proceeds to step ST304. That target torque is a value determined by an engine output torque and the heat-resisting property of the clutch.

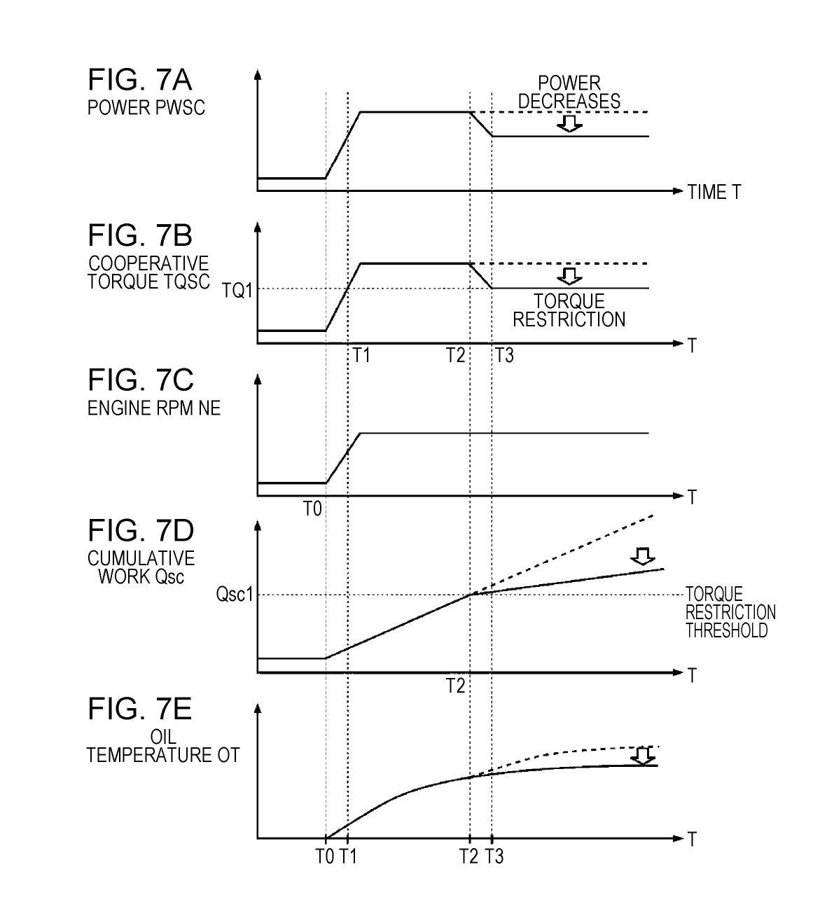

FIGS. 7A to 7E illustrate examples of changes with respect to time (hereinafter referred to as “patterns”) in power PWSC, cooperative torque TQSC, engine RPM NE, cumulative work Qsc, and oil temperature OT when the vehicle starts climbing a steep hill (in a continuous stall condition) according to the embodiment of the invention. Each vertical axis indicates a value of each parameter. Each horizontal axis indicates the time axis.

As the engine RPM NE gradually increases from time T0, other parameters also gradually increase.

Time T1 indicates the time when the cooperative torque TQSC exceeds TQ1. Time T2 indicates the time when the cumulative work Qsc exceeds the specific value Qsc1 for restricting the output torque (torque restriction threshold). Time T3 indicates the time when the cooperative torque TQSC is restricted by the value of TQ1.

At time T1, because the cooperative torque TQSC is above TQ1, but the cumulative work Qsc is not above Qsc1, the torque is not restricted until time T2.

After time T2, each of the power PWSC, cooperative torque TQSC, cumulative work Qsc, and oil temperature OT is indicated by two patterns of broken and solid lines. The solid line indicates a pattern when the engine output torque is restricted according to the present embodiment; the broken line indicates a pattern when it is not restricted.

When the engine output torque is not restricted (indicated by the broken line), after time T2, the cumulative work Qsc and the oil temperature OT gradually increase. In contrast, when the output torque is restricted (indicted by the solid line), because the cooperative torque TQSC gradually decreases between time T2 and time T3, the power PWSC also gradually decreases, and an increase in the cumulative work Qsc and the oil temperature OT is more gentle than that when the output torque is not restricted. At time T3, the cooperative torque TQSC is constant at TQ1, and the power PWSC is also constant. In FIG. 7B, the target torque is indicated by TQ1.

Referring back to FIG. 6, in step ST304, the larger one of the target torque and the difference between the preceding cooperative torque TQSC and a reduction value DTQ is set as the cooperative torque TQSC, and the process proceeds to step ST305. The reduction value DTQ is previously set as a fixed value for reduction. Referring to FIG. 7B, for the period from time T2 to time T3, the cooperative torque TQSC gradually decreases; after time T3, it is constant at TQ1. The period for which the difference between the preceding cooperative torque TQSC and the reduction value DTQ is large corresponds to the period between time T2 and time T3. The period for which the target torque is large corresponds to the period after time T3.

Referring back to FIG. 6, in step ST305, a continuous cooperative state is turned on, and the process proceeds to step ST306. The continuous cooperative state indicates a state in which, at the preceding cooperative torque setting, a torque smaller than the accelerator pedal request torque TQAP is set.

In step ST306, the set cooperative torque TQSC is controlled so as to be substantially the same as the engine output torque. Then, the process is completed.

If the accelerator pedal request torque TQAP is at or below the target torque (NO in step ST303), the process proceeds to step ST307. In step ST307, the accelerator pedal request torque TQAP is set as the cooperative torque TQSC, and the process proceeds to step ST308.

In step ST308, because the cooperative torque TQSC is not restricted, a continuous cooperative state is turned off, and the process proceeds to step ST306.

If the precondition is not effective (NO in step ST300), if the protection control mode is OFF (NO in step ST301), or if the power PWSC does not exceed the specific value PW4 (NO in step ST302), the process proceeds to step ST309.

In step ST309, it is determined whether the present state is in a continuous cooperative state. If it is not in a continuous cooperative state (NO in step ST309), because it is not necessary to restrict an output torque, the process proceeds to step ST307. If it is in a continuous cooperative state (YES in step ST309), the process proceeds to step ST310.

In step ST310, the smaller one of the sum of the preceding cooperative torque TQSC and an addition value DTQ and the accelerator pedal request torque TQAP is set as the cooperative torque TQSC, and the process proceeds to step ST311. Here, even if it is not necessary to restrict an output torque at the present time, in order to prevent a sharp change in the output torque caused by setting the accelerator pedal request torque TQAP as the cooperative torque TQSC when the output torque was restricted at the preceding time, the addition value DTQ is set to gradually increase the output torque.

In step ST311, it is determined whether the cooperative torque TQSC set in step ST310 is below the accelerator pedal request torque TQAP. If the cooperative torque TQSC is below the accelerator pedal request torque TQAP (YES in step ST311), the process proceeds to step ST306; otherwise (NO in step ST311) the process proceeds to step ST308. That is, in the present control period, if the engine output torque is not restricted, a continuous cooperative state is turned off.

Steps ST301 to ST304, ST309, and ST310 correspond to the torque output restricting unit of the embodiment of the present invention.

As described above, in a transient engagement state of the clutch, when the oil temperature OT is above a specific value or the cumulative work Qsc is above the specific value Qsc1 determined by the oil temperature OT, if the power PWSC of the starting clutch is high, the engine output torque is restricted.

Accordingly, because the engine output torque is restricted for continuation of a continuous stall condition, such as in starting climbing a hill, deterioration in the clutch can be prevented. If the temperature of the clutch is high, because an increase of the temperature can be prevented by restriction of the engine output torque, it is not necessary to increase cooling performance and thus the size of the oil pump can be reduced. Therefore, an increase in the oil friction and a decrease in fuel efficiency can be avoided.

According to the embodiment of the present invention, when the cumulative work of the starting clutch (specifically, the amount of heat stored in the starting clutch) is above a specific value, an increase in the cumulative work can be reduced by restriction of the output torque of the driving source. This can avoid the starting clutch from reaching an impermissible temperature and thus prevent deterioration in the starting clutch. In addition, because a large-capacity oil pump for cooling is not necessary, a decrease in fuel efficiency can be prevented.

In the starting-clutch control apparatus, the cumulative work calculating unit may preferably include a power calculating unit that calculates power of the starting clutch based on the pressure acting on the starting clutch, the number of revolutions of the driving shaft, and the number of revolutions of the driven shaft. The torque output restricting unit may preferably restrict the output torque of the driving source of the vehicle when the starting clutch is in the transient engagement state, the cumulative work exceeds the first specific value, and the power exceeds a second specific value.

That is, when the cumulative work of the starting clutch (specifically, heat amount of heat stored in the starting clutch) is above a specific value, if a load with high power (specifically, heat that is large with respect to cooling performance) further occurs, a further increase in the output torque can be reduced by restriction of the output torque of the driving source. This can avoid the starting clutch from reaching an impermissible temperature and thus prevent deterioration in the starting clutch. In addition, because a large-capacity oil pump for cooling is not necessary, a decrease in fuel efficiency can be prevented.

In the starting-clutch control apparatus, the cumulative work calculating unit may preferably calculate the cumulative work based on the power such that the cumulative work is at or above the cumulative work at the present time when the starting clutch is in the transient engagement and may preferably calculate the cumulative work based on the power such that the cumulative work is below the cumulative work at the present time when the starting clutch is not in the transient engagement state.

That is, in the transient engagement state of the starting clutch, the cumulative work is calculated based on the power so as to be at or above the cumulative work at the present time. That is, during the transient engagement state of the starting clutch, the cumulative work increases or remains unchanged.

When the starting clutch is not in the transient engagement state, the cumulative work is calculated based on the power so as to be below the cumulative work at the present time. That is, while the starting clutch is not in a transient engagement state, the cumulative work decreases or remains unchanged.

With this, when the starting clutch is in a transient engagement state, where heat occurs, the cumulative work increases; when the starting clutch is in a non-transient engagement state, where no heat occur, the cumulative work decreases. Therefore, increase and decrease in the cumulative work can support heat occurring in the starting clutch, and the cumulative work can be accurately calculated.

The starting-clutch control apparatus may preferably further include a temperature estimating unit that estimates a temperature of working fluid of the starting clutch. The torque output restricting unit may preferably determine the first specific value in accordance with the temperature.

With this, the temperature of working fluid of the starting clutch can be estimated using the temperature estimating unit, and the output torque of the driving source can be appropriately restricted in response to the temperature.

The starting-clutch control apparatus may preferably further include a second torque output restricting unit that restricts the output torque of the driving source of the vehicle when the temperature exceeds a third specific value.

With this, even if the cumulative work is small, when the temperature reaches an impermissible temperature, the output torque of the driving source can be appropriately restricted by the second torque output restricting unit.

Obviously, numerous modifications and variations of the present invention are possible in light of the above teachings. It is therefore to be understood that within the scope of the appended claims, the invention may be practiced otherwise than as specifically described herein.

What is claimed is:

1. A starting-clutch control apparatus to control connection between a driving side and a driven side of a vehicle using a starting clutch disposed therebetween, the starting-clutch control apparatus comprising:
a driving-shaft rotation speed detector configured to detect a rotation speed of a driving shaft of the starting clutch;
a driven-shaft rotation speed detector configured to detect a rotation speed of a driven shaft of the starting clutch;
a cumulative work amount calculator configured to calculate a cumulative work amount of the starting clutch based on pressure applied to the starting clutch, the rotation speed of the driving shaft, and the rotation speed of the driven shaft; and
a torque output restricting device configured to restrict an output torque of a driving source of the vehicle when the starting clutch is in a transient engagement state and the cumulative work amount exceeds a first specific value.

2. The starting-clutch control apparatus according to claim 1,
wherein the cumulative work amount calculator includes a power calculator configured to calculate power of the starting clutch based on the pressure applied to the starting clutch, the rotation speed of the driving shaft, and the rotation speed of the driven shaft, and
wherein the torque output restricting device is configured to restrict the output torque of the driving source of the vehicle when the starting clutch is in the transient engagement state, the cumulative work amount exceeds the first specific value, and the power exceeds a second specific value.

3. The starting-clutch control apparatus according to claim 2, wherein the cumulative work amount calculator is configured to calculate the cumulative work amount based on the power such that the cumulative work amount is at or above the cumulative work amount at the present time when the starting clutch is in the transient engagement and configured to calculate the cumulative work amount based on the power such that the cumulative work amount is at or below the cumulative work amount at the present time when the starting clutch is not in the transient engagement state.

4. The starting-clutch control apparatus according to claim 1, further comprising a temperature estimating device configured to estimate a temperature of working fluid of the starting clutch,
wherein the torque output restricting device is configured to determine the first specific value in accordance with the temperature.

5. The starting-clutch control apparatus according to claim 4, further comprising a second torque output restricting device configured to restrict the output torque of the driving source of the vehicle when the temperature exceeds a third specific value.

6. The starting-clutch control apparatus according to claim 2, further comprising a temperature estimating device configured to estimate a temperature of working fluid of the starting clutch,
wherein the torque output restricting device is configured to determine the first specific value in accordance with the temperature.

7. The starting-clutch control apparatus according to claim 3, further comprising a temperature estimating device configured to estimate a temperature of working fluid of the starting clutch,
wherein the torque output restricting device is configured to determine the first specific value in accordance with the temperature.

8. The starting-clutch control apparatus according to claim 6, further comprising a second torque output restricting device configured to restrict the output torque of the driving source of the vehicle when the temperature exceeds a third specific value.

9. The starting-clutch control apparatus according to claim 7, further comprising a second torque output restricting device configured to restrict the output torque of the driving source of the vehicle when the temperature exceeds a third specific value.

10. A starting-clutch control apparatus to control connection between a driving side and a driven side of a vehicle using a starting clutch disposed therebetween, the starting-clutch control apparatus comprising:
driving-shaft rotation speed detection means for detecting a rotation speed of a driving shaft of the starting clutch;
driven-shaft rotation speed detection means for detecting a rotation speed of a driven shaft of the starting clutch;
cumulative work amount calculation means for calculating a cumulative work amount of the starting clutch based on pressure applied to the starting clutch, the rotation speed of the driving shaft, and the rotation speed of the driven shaft; and
torque output restricting means for restricting an output torque of a driving source of the vehicle when the starting clutch is in a transient engagement state and the cumulative work amount exceeds a first specific value.
